(19) United States
(12) Patent Application Publication
(10) Pub. No.: US 2017/0263237 A1
(43) Pub. Date: Sep. 14, 2017

(54) SPEECH SYNTHESIS FROM DETECTED SPEECH ARTICULATOR MOVEMENT

(71) Applicant: The University of Hull, Hull, Humberside (GB)

(72) Inventors: Philip Duncan Green, Sheffield (GB); Roger Kenneth Moore, Sheffield (GB); James Michael Gilbert, Hull (GB); Jose Andres Gonzalez Lopez, Sheffield (GB)

(21) Appl. No.: 15/511,784

(22) PCT Filed: Sep. 10, 2015
(86) PCT No.: PCT/GB2015/052612

§ 371 Date: Mar. 16, 2017

(30) Foreign Application Priority Data
Sep. 16, 2014 (GB) 1416303.4

(51) Int. Cl. G10L 13/04; G10L 15/24; G10L 13/08

(52) U.S. Cl. CPC G10L 13/04; G10L 13/08; G10L 15/24

(57) ABSTRACT

The present invention relates to methods and systems for generating synthesized speech from detected speech articulator movement and to methods and systems for generating models for generating synthesized speech from detected articulator movement.

### TECHNICAL FIELD

The present invention relates to methods and systems for generating synthesised speech from detected speech articulator movement and to methods and systems for generating models for generating synthesised speech from detected articulator movement.

### BACKGROUND

Synthesising human speech is useful in a number of applications. Such applications include “text-to-speech” software in which data, for example a text file, is converted into speech. This can be useful for enabling those with a visual impairment to have written material automatically “read” to them.

Other applications are concerned with enabling a person with impaired speaking ability, for example a person who has undergone a medical procedure such as a laryngectomy, to synthesise speech. In such cases a text-to-speech type arrangement can be employed, however, this is of limited utility for day-to-day use as it requires a user to operate a device, such as a keyboard, to produce speech. Such a techniques are slow and cumbersome.

A better solution, specifically for those who still retain control of some of their vocal tract articulators (e.g. the tongue, the jaws, the lips and so on), is to provide a system which is able to convert articulator movement into synthesised speech. These techniques involve sensors which detect and then generate data corresponding to articulator movement, and then use software to convert the detected articulator movement into audible speech.

Present techniques achieve this by providing software that matches certain combinations of articulator movements either with specific words and/or phones. These techniques rely on a “recognition” step in which the words and/or phones that a user is attempting to speak must be recognised before the speech can be synthesised. Once the specific word or phone associated with the detected articulator movement has been recognised, then audible speech can be generated by the methods used for text-to-speech synthesis.

However, such techniques have significant drawbacks. For example, typically, speech synthesis does not start until a series of consecutive words and/or phones have been recognised. This is equivalent to using a human interpreter. As a result, undesirable delays can be introduced into the synthesised speech making it harder for a listener to understand the synthesised speech and distracting or confusing the speaker as the synthesised speech being produced lags behind what they are currently trying to say. Further, unless adaptations have been made, the speech produced will not sound like the user's own voice.

It is an aim of the present invention to provide a speech synthesis technique that addresses at least some of the drawbacks of these techniques.

### SUMMARY OF THE INVENTION

In accordance with a first aspect of the invention there is provided a method of synthesising speech, comprising inputting articulator movement data to a conversion model, said conversion model comprising parameters representing a relationship between speech articulator movements and speech sound; transforming by the conversion model said articulator movement data into synthesised speech sound data in accordance with the parameters, wherein the parameters of said conversion model are estimated based on training articulator movement data and training speech sound data, said training speech sound data associated with training speech sound and said training articulator movement data associated with articulator movement of a user produced in accordance with the training speech sound.

Aptly, the training speech sound is produced by the user and said training articulator movement data is associated with articulator movement produced when the user produces the training speech sound.

Aptly, the training articulator movement data is associated with articulator movement produced by the user when the user mouths along with the training speech sound.

Aptly, the articulator movement data input to the conversion model corresponds to input articulator movement feature vectors.

Aptly, the synthesised speech sound data comprises output speech feature vectors produced by the conversion model when transforming the input articulator movement feature vectors.

Aptly, the output speech feature vectors are estimated from the articulator movement feature vectors by applying a non-linear transformation that depends on the conversion model parameters.

Aptly, the method further comprises converting the synthesised speech sound data to an audible time domain signal.

In accordance with a second aspect of the invention there is provided a method of generating a conversion model for synthesising speech, said method comprising: receiving training articulator movement data and training speech sound data, said training speech sound data associated with training speech sound and said training articulator movement data associated with articulator movement of a user produced in accordance with the training speech sound, and estimating parameters of the conversion model based on the training articulator movement data and training speech sound data, said parameters representing a relationship between articulator movement and speech sound.

Aptly, the training speech sound is produced by the user and said training articulator movement data is associated with articulator movement produced when the user produces the training speech sound.

Aptly, the training articulator movement data is associated with articulator movement produced by the user when the user mouths along with the training speech sound.

Aptly, the method according to either the first aspect or second aspect further comprises extracting the training speech sound data from speech sound signals captured when the user makes the training speech sound, and extracting the training articulator movement data from articulator movement signals captured when the user produces the training speech sound.

Aptly, in the method according to the first aspect or second aspect, the articulator movement signals are captured using a permanent magnetic articulography technique.

Aptly, in the method according to the first aspect or second aspect, capturing the speech sound signals and capturing the articulator movement signals occurs substantially simultaneously.

Aptly, in the method according to the first aspect or second aspect, the training speech sound data comprises training speech feature vectors, and the training articulator movement data comprises articulator movement feature vectors.

Aptly, the method according to either the first aspect of second aspect further comprises using a training procedure to estimate the parameters given the training speech feature vectors and the training articulator movement feature vectors, the parameters defining a joint or conditional probability distribution associating articulator movement feature vector input to the conversion model with output speech sound feature vectors output from the conversion model.

In such examples, the method therefore comprises estimating the parameters of the conversion model through a training procedure (using in certain embodiments maximum likelihood estimation) given the training speech feature vectors and the training articulator movement feature vectors.

In certain embodiments, the conversion model defines a joint probability distribution over the articulator movement feature vector and the speech feature vectors.

Aptly, in the method according to the first or second aspect, the conditional probability distribution is represented either as a recurrent neural network or as a statistical mixture model comprising a number of probability distributions weighted by corresponding mixture weights.

Aptly, the recurrent neural network is a long short term memory (LSTM) recurrent neural network.

Aptly, in the method according to the first or second aspect, the statistical mixture model is a mixture of factor analysers (MFA).

Aptly, the method according to the first or second aspect further comprises, estimating parameters of the conversion model (for example based either on a mixture of factor analysers (MFA) or a long short term memory recurrent neural network (LSTM-RNN)) from the training articulator movement feature vectors and the training speech feature vectors using a stochastic gradient descent algorithm (for an LSTM-RNN based conversion model) or an expectation maximization (EM) algorithm (for an MFA based conversion model).

Aptly, the method according to the first or second aspect further comprises extracting the training speech feature vectors from the speech sound signals using linear predictive coding (LPC).

Aptly, the method according to the first or second aspect further comprises extracting the training articulator movement feature vectors from the articulator movement signals using principal component analysis (PCA).

In accordance with an third aspect of the invention there is provided a system for synthesising speech, comprising a conversion model implemented on a data processor, said conversion model comprising parameters representing a relationship between speech articulator movements and speech sound, said conversion model arranged to receive input articulator movement data, and responsive to receiving the input articulator movement data, to transform the input articulator movement data into synthesised speech sound data in accordance with the parameters, wherein the parameters of the conversion model are estimated based on training articulator movement data and training speech sound data, said training speech sound data associated with training speech sound and said training articulator movement data associated with articulator movement of a user produced in accordance with the training speech sound.

In accordance with a fourth aspect of the invention there is provided a system for generating a conversion model for synthesising speech, said conversion model implemented on a data processor, said data processor arranged to receive training articulator movement data and training speech sound data, said training speech sound data associated with training speech sound and said training articulator movement data associated with articulator movement of a user produced in accordance with the training speech sound, and to estimate parameters of the conversion model based on the training articulator movement data and training speech sound data, said parameters providing an association between articulator movement and speech sound.

In accordance with a fifth aspect of the invention there is provided a computer program comprising computer implementable instructions which when executed on a computer, cause the computer to perform the method of synthesising speech according to the first aspect of the invention.

In accordance with a sixth aspect of the invention, there is provided a computer program comprising computer implementable instructions which when executed on a computer, cause the computer to perform the method of generating a conversion model according to the second aspect.

In accordance with an seventh aspect of the invention, there is provided a computer program product on which is stored a computer program as defined in either the fifth aspect or sixth aspect.

In accordance with certain embodiments of the present invention, a technique is provided that facilitates “direct” speech synthesis. That is, detected articulator movement is converted directly into synthesised speech without the need of an intermediate recognition step in which an attempt is made to recognise what words or phones a user is attempting to speak.

This is achieved by the provision of a conversion model, specifically a statistical conversion model that comprises parameters associating features of speech sound with features of the user's articulator movement.

In certain embodiments, the conversion model can be generated during a training process in which speech signals and corresponding articulator movement signals are captured (typically synchronously). Features can be extracted from these signals and statistical processing used to set the conversion model parameters which define a probability distribution associating input articulator movement data with output speech sound.

In accordance with this technique, characteristics of a user's voice are retained such as accent and dialect. Furthermore, the burdensome requirement to generate extensive libraries of words and phones, or training an individual voice model, is overcome.

In certain embodiments, for example where the user cannot produce any audible speech sound during model training, pre-recorded speech sound can be used which the user “mouths along” to. This can be pre-recorded speech sound from the user themselves or from another person who thereby provides a “donor voice”.

In certain embodiments, the technique can also be implemented in a computationally efficient manner, such that the processing required to synthesise a user's voice can be carried out on a conventional device, such as a smartphone.

Various further aspects and features of the invention are defined in the claims.

### BRIEF DESCRIPTION OF FIGURES

Certain embodiments of the present invention will now be described hereinafter, by way of example only, with reference to the accompanying drawings in which:

FIG. 1 provides a schematic diagram of a system for implementing a conversion model training process;

FIG. 2 provides a schematic diagram of an example of a speech feature data extraction process;

FIG. 3 provides a schematic diagram of an example of an articulator movement feature data extraction process;

FIG. 4 provides a schematic diagram of a system for implementing speech synthesis;

FIG. 5 provides a schematic diagram of an example of an audio conversion process, and

FIG. 6 provides a schematic diagram of an example of a speech synthesis process.

Like references in the drawings refer to like parts.

### DETAILED DESCRIPTION

In accordance with examples of the invention, techniques are provided that enable detected articulator movement to be converted into audible synthesised speech.

As is known, “articulators” are parts of the human vocal tract that move when a person speaks (i.e. produces “speech sound”). Articulators include the tongue, the jaws, the lips, the larynx and so on. The speech sound produced by a human is dependent on movement of the articulators within the vocal tract. In accordance with certain embodiments of the invention, a technique is provided in which an estimation is made of the speech sounds made by a person based only on information representing the movement of the person's articulators. This allows a person's speech to be “synthesised” based on articulator movement alone. Such a technique can be useful in a number of applications, for example synthesising speech for people who have undergone medical procedures such as laryngectomies. Such people have their ability to produce audible speech sound very much reduced but still retain the ability to move at least some of their vocal tract articulators as if they were producing speech sound.

Other applications relate to so-called “silent speech” techniques in which a user moves their articulators as if speaking normally but without actually vocalising the speech sounds. Such techniques can facilitate “silent” communication, such as “silent” telephone calls. Information relating to the user's articulator movement is transmitted in place of information associated with the audible speech sound. The articulator movement information can then be used to synthesise the user's speech at a remote receiver, for example the telephone of another user. This technique can improve user privacy and enable communication to take place in environments in which vocal communication is undesirable or prohibited.

In accordance with certain embodiments of the invention, captured articulator movement data (i.e. data quantifying detected articulator movement) can be input to a speech synthesis process that converts the input articulator movement data into audible synthesised speech. This conversion is based on a predetermined statistical relationship between articulator movements and speech sounds. More specifically, this process can be achieved by a statistical “conversion” model that defines an association (i.e. relationship) between input articulator movement data (i.e. articulator movement input to the conversion model) and output speech sound data. More specifically, parameters of the model represent a relationship between speech articulator movements and speech sound. Input articulator movement data is “transformed” by the model into corresponding “synthesised” speech sound data.

Satisfactory implementation of such a speech synthesis process is complicated by the fact that the relationship between articulator movement and corresponding speech sound produced varies from person to person. In certain embodiments, for the speech synthesis process to work well for any particular individual, and to produce sounds that resemble that person's voice, the conversion model can be “trained” to reflect the particular speech sounds produced by that individual.

To generate such a model, a model training process is undertaken in which “training” speech sound signals are captured as a user makes various speech sounds. At the same time (i.e. substantially simultaneously) training articulator movement data is captured from signals associated with the movement of the user's speech articulators. If necessary, this data is then stored.

Feature data, which can be used in statistical analysis, is then extracted from the captured training speech sound signals and from the training articulator movement signals. This feature data is processed in order to estimate the parameters of the statistical conversion model. Once the parameters are estimated the model is deemed “trained”, and can be used in a speech synthesis process to convert detected articulator movement data into speech sound data for a particular user.

In other embodiments, where it may not be possible for the user to generate the training speech sound (for example if a laryngectomy has already occurred), pre-recorded training speech sound can be used. This can be from the user themselves or from another person providing a “donor voice”. In such embodiments, a user “mouths along” with the pre-recorded speech sound. That is, as the pre-recorded speech sound is played back to the user, the user at the same time moves their articulators as if they were making the speech sounds themselves. This process allows articulator movement signals to be generated and captured that correspond in time with the pre-recorded speech sound signals.

Feature data is extracted from the articulator movement signals which are captured as discussed above and feature data is extracted from the pre-recorded speech sound.

As will be explained in more detail below, typically, the feature data generated from the articulator movement signals is in the form of articulator movement feature vectors. Similarly, the feature data generated from the speech sound signals is in the form of speech feature vectors.

When generating output speech feature vectors for voice synthesis, a statistical estimation method is employed (in some examples a minimum mean square error (MMSE) estimation technique) based on the model parameters and the input articulator movement feature vectors. Further, once the output speech sound features are generated, they are converted into an audible time domain signal. Examples of this are described in more detail below.

Articulator movement signals can be captured using any suitable technique. Such suitable techniques include Permanent Magnetic Articulography (PMA) [1]. PMA is a technique for detecting the movement of certain articulators of the vocal tract by attaching a number of small magnets to various articulators (e.g. the tongue and lips) of a human subject (“the user”).

As the user speaks, the articulators of the vocal tract move and, correspondingly, the magnets attached to the articulators move. This movement can be detected by a magnetic sensor arrangement positioned relative to the user. For example, the user can wear a rigid frame (i.e. one with a substantially fixed position relative to the user's articulators), on which are mounted a number of triaxial magnetic sensors. Changes in the magnetic field caused by movement of the magnets mounted on the articulators are detected by the tri-axial magnetic sensors allowing three spatial components (x,y,z) corresponding to the movement, relative to the sensors, of the magnets fixed on the articulators to be captured. The output of the magnetic sensors is then used to generate the articulator movement data described above and can therefore be used during the model training process and during the speech synthesis process.

In a typical implementation of PMA, the user would have up to six magnets attached to the articulators (two on the upper lip, two on the lower lip, one at the tip of the tongue and one on the hump of the tongue). These magnets are typically around 1-2 mm diameter cylinders with a length of 4-5 mm and may either be attached to the surface of the articulators using an adhesive or may be coated in a biocompatible coating and implanted within the articulators. The sensing system would be composed of three tri-axial magnetic sensors held close the cheek and lips on a rigid arm attached to a pair of glasses. A further reference tri-axial magnetic sensor may be mounted on the same rigid frame to permit cancellation of the earth's magnetic field. Examples of such implementations are known in the art, for example those described in international patent application WO2006/075179 A1.

### Example Conversion Model Training Process

There now follows a description of an example conversion model training process. In this example, parameters of a conversion model are generated from ‘parallel’ synchronous (i.e. simultaneous) recordings comprising speech sound signals captured by a microphone and articulator movement signals captured using a PMA based technique as described above.

A user, for example a person due to undergo a laryngectomy but who currently possess normal speaking ability, reads a predetermined passage of text. The user's speech is captured with a microphone and recorded. At the same time (i.e. synchronously) a PMA device captures corresponding articulator movement and the associated articulator movement signals are also recorded.

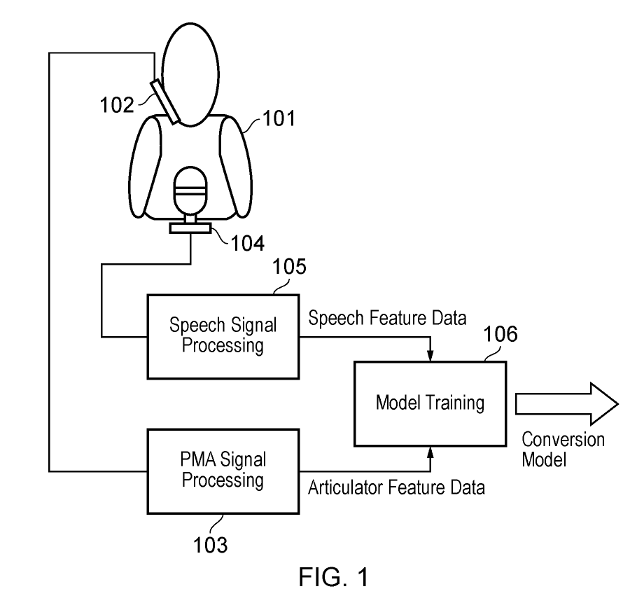

The speech sound signals and the articulator movement signals are then processed separately in order to extract a set of representative features that can be used for estimating the parameters of the statistical conversion model. An overview of this process is shown in FIG. 1.

FIG. 1 provides a schematic diagram of a system for implementing a conversion model training process.

FIG. 1 shows a user 101 positioned relative to a PMA device 102 which is arranged to detect the movement of magnets fixed on some of the user's articulators and to generate corresponding articulator movement signals (i.e. “PMA signals”). The PMA device 102 is coupled to a PMA signal processing block 103 and PMA signals generated by the PMA device 102 are input to the PMA signal processing block 103. A microphone 104 is positioned relative to the user 101 and is arranged to detect speech sounds made by the user 101. The microphone 104 is coupled to a speech signal processing block 105 and speech sound signals generated by the microphone 104 are input to the speech signal processing block 105.

Although not shown in FIG. 1, in some examples, the speech sound signals generated by the microphone 104 and the PMA signals generated by the PMA device 102 are recorded by intermediate signal recording devices and stored on a suitable storage medium such as a computer disk, before being input respectively into the speech signal processing block 105 and the PMA signal processing block 103. As will be understood, such an arrangement allows for the speech sound signals and PMA signals to be captured at a different time to when they are processed to generate the conversion model.

The speech signal processing block 105 is arranged to extract speech feature data from the speech sound signals and the PMA signal processing block 103 is arranged to extract articulator movement feature data from the articulator movement signals. As an output, the PMA signal processing block 103 and the speech signal processing block each output two sequences of feature data of the same length M. Specifically, the speech signal processing block 105 outputs speech feature data comprising speech feature vectors Y=(y₀, y₁, . . . , y_{M-1}) and the PMA signal processing block 103 outputs articulator movement feature data comprising articulator movement feature vectors X=(x₀, x₁, . . . , x_{M-1}). Together, the speech feature vectors Y and the articulator movement feature vectors X form a “training dataset” which is used to estimate the parameters of the conversion model used for speech synthesis

The speech signal processing block 105 and the PMA signal processing block 103 are coupled to a model training block 106. The model training block 106 is arranged to process the speech feature data (i.e. speech feature vectors Y) and articulator movement feature data (i.e. articulator movement feature vectors X) and from this estimate the parameters of the conversion model.

In this example, the conversion model is a statistical model \hat{Θ} representing the relationship between speech features vectors and articulator movement features vectors. In certain embodiments, a generative model representing the joint probability distribution of speech and articulator movement feature vectors can be represented by a MFA model and trained using a statistical estimation method such as Maximum Likelihood Estimation.

$$\hat{Θ} = arg {max}_{Θ} p ( X , Y \vert Θ ) . \qquad ( 1 )$$

Once generated, the model \hat{Θ} can be used as a conversion model, as described above, in a speech synthesis process.

In other embodiments, a discriminative model such as a long short term memory (LSTM) recurrent neural network can be trained using standard error backpropagation algorithm. This model, in contrast to the generative model described above, directly represents the conditional distribution of the speech feature vectors given the articulator movement features vectors.

As will be understood, the speech signal processing block 105, the PMA signal processing block 103 and the model training block 106 described with reference to FIG. 1 are principally logical designations grouping together a number of related data processing processes and functions. Typically, the data processing performed by these blocks (e.g. the various “stages” explained in more detail below) will be undertaken by a suitably programmed computer system comprising memory and one or more data processors. Accordingly, the arrangement shown in FIG. 1 can be provided by a computer system (e.g. a personal computer) on which is running software providing the speech signal processing, the PMA signal processing and the model training processing processes, and the computer system includes a data input interface suitable for receiving the speech sound signals and the PMA signals.

The speech signal processing block 105, the PMA signal processing block 103 and the model training block 106 are described in further detail below.

### Speech Signal Processing Block

The speech signal processing block 105 is arranged to extract from the speech sound signals speech feature data. Criteria for the technique used in the speech feature extraction processing provided by this block is that the resultant speech feature data provides a low-dimensional representation of the speech sound signals having the following properties: (i) the representation enables high-quality speech synthesis, (ii) the representation is suitable for statistical modelling, and (iii) the representation can be extracted in a computationally efficient manner.

There are a number of statistical processing techniques that are suitable for extracting speech feature data from the speech sound signals that meet these criteria. Examples of these techniques are Linear Predictive Coding (LPC) analysis [2] and its alternative representations (e.g. Line Spectral Pairs (LSP) [3], Log Area Ratios (LAR) [4], and LPC-Cepstral coefficients [4]), Mel-Frequency Cepstral Coefficients (MFCC) [5], Mel-generalized Cepstral Coefficients (MGCC) [6], and Mel-Generalized Cepstrum-based Line Spectrum Pairs (MGC-LSP) [6].

In the following example, speech LSP parameterisation is described in detail.

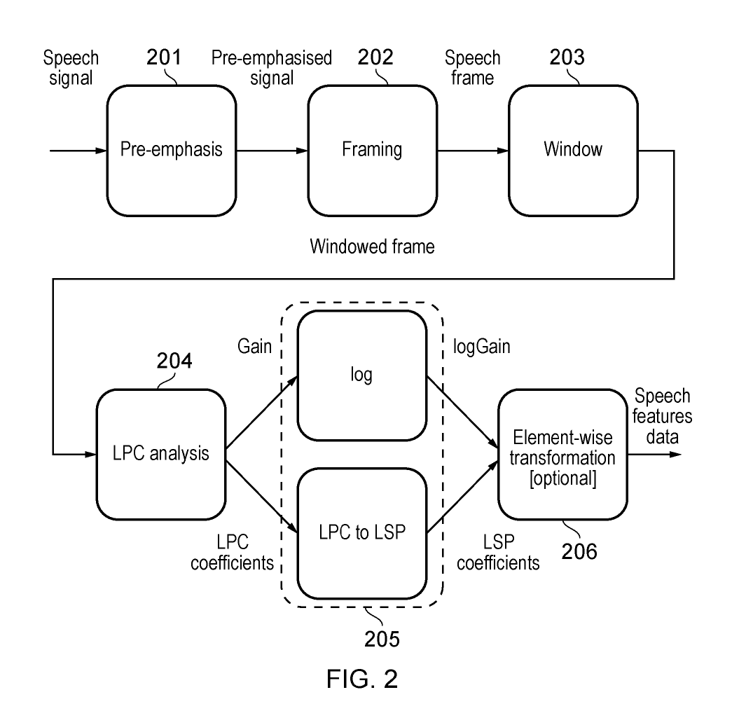

FIG. 2 provides a schematic diagram of an example of a speech feature data extraction process performed by the speech signal processing block 105. This process includes steps for representing the input speech sound signals as a set of LSP coefficients.

At a first pre-emphasising stage, 201, the speech sound signal, in the time domain, is pre-emphasised as follows:

s′(n)=s(n)−αs(n−1), (2)

where s(n) denotes the n-th speech sample before pre-emphasis, s′(n) represents the signal after pre-emphasis, and α=0.97 typically.

At a second framing stage, 202, the pre-emphasised speech sound signal is partitioned into a series of overlapping frames of length ω ms and shifted δ ms.

At a third windowing stage 203, a window function is applied to each frame. Here, a Hamming window of the same width as the frame length is chosen.

At a fourth analysis stage 204, parameters describing the vocal tract shape of the user 101 are estimated from the windowed speech signal using Linear Predictive Coding (LPC) analysis [2].

Let s̅(n) and u(n) denote the windowed speech and excitation signals, respectively. The fourth analysis stage 204, performs an LPC analysis and estimates the q+1 parameters y=(a₁, . . . , a_{q}, G) from the windowed frame that minimize the prediction error:

e(n)=(\hat{s}(n)−s̅(n))², (3)

with

$$\hat{s} ( n ) = {\sum }_{i = 1}^{q} {a}_{i} \overline{s} ( n - i ) + Gu ( n ) , \qquad ( 4 )$$

where aᵢ (i=1, . . . , q) are the parameters of the linear filter representing the vocal tract and G is the gain parameter.

At a fifth transforming stage 205, the parameters describing the user's vocal tract are transformed into alternative representations more suitable for statistical modelling. In particular, a logarithmic compression is applied to the gain parameter G, whereas the filter coefficients (a₁, . . . , aₚ) are transformed to Line Spectral Pairs (LSP) [3], which have several properties that make them superior to LPC coefficients for modelling purposes.

At a sixth transformation stage 206, an optional element-wise transformation is applied to the speech parameters y=(a₁, . . . , a_{q}, G), that is, the logarithmic gain and LSP coefficients. Here, all the parameters are normalized taking into account the mean and standard deviation estimated for the training dataset. The sixth stage 206 outputs speech feature data in the form of speech feature vectors.

Hereinafter, the resulting speech feature vector obtained at time t=0, 1, . . . will be denoted as yₜ.

### PMA Signal Processing Block

The PMA signal processing block 103 is arranged to extract from the PMA signals articulator movement feature data suitable for statistical modelling.

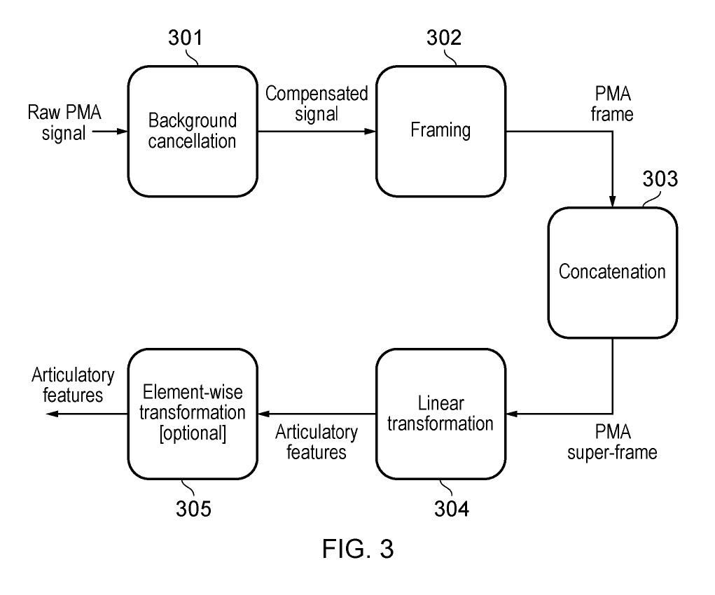

FIG. 3 provides a schematic diagram of an example of an articulator movement feature data extraction process performed by the PMA signal processing block 105.

As shown in FIG. 3, the input to this block is the “raw” articulator movement signals captured by the PMA device 102 (the “PMA signals”). The output is articulator movement feature data in the form of a set of articulator feature vectors extracted from the input articulator movement signals.

At a first noise cancelation stage 301, the input articulator movement signals are processed to cancel the effect of the earth's magnetic field. Additionally, at this stage, ‘magnetic noise’ captured by the sensors can be cancelled. The magnetic noise can be due to, for example, to involuntary movements of the user's head while he/she is speaking.

In order to achieve this, the PMA device 102 is equipped with a reference sensor that is arranged to capture external magnetic fields not generated by the articulators. Information generated from this reference sensor can be used at the first noise cancellation stage to perform the cancellation on the signals acquired by the other sensors.

At a second framing stage 302, a sequence of PMA samples (o₀, o₁, . . . , o_{N-1}) is partitioned into a series of overlapping frames (ō₀, ō₁, . . . , ō_{M-1}), where oₜ=(oₜ(0), . . . , oₜ(d−1))^{T} is the d-dimensional vector containing the compensated PMA sample at time t.

The frame extraction at the second framing stage 302 is arranged to be synchronous with the speech frame extraction, that is with the framing performed by the second framing stage 202 of the speech signal processing block 105 described with reference to FIG. 2. Thus, the values of length of the analysis window and frame period are the same as those used for the speech sound signal analysis.

Let ω and δ denote the values in ms of the analysis window and frame period used in both the second framing stage 202 of the speech sound signal processing block 105 and the second framing stage 302 of the PMA signal processing block 103. Similarly, ωₒ and δₒ represent the values of ω and δ expressed in number of PMA samples. Then, the t-th PMA frame is formed as follows:

ōₜ=(o_{t×δ}_{ₒ}^{T}, . . . ,o_{t×δ}_{ₒ}_{+ω}_{ₒ}₋₁^{T})^{T}. (5)

At a third concatenation stage 303, PMA frames output from the second framing stage 302 are concatenated to form super-frames. In particular, a super-frame Oₜ is computed for each frame ōₜ by concatenating its preceding and succeeding K frames as follows,

Oₜ=(ō_{t-K}^{T}, . . . ,ōₜ^{T}, . . . ,ō_{t+K}^{T})^{T}. (6)

Next, at a fourth transformation stage 304, each super-frame Oₜ is linearly transformed to obtain a set of articulator features xₜ. These set of articulator features form the articulator feature vectors. The form of the linear transformation applied to the super-frame is,

xₜ=WÕₜ, (7)

where Õₜ=(Oₜ^{T}, 1, 1, . . . , 1)^{T} is the (2×l)-dimensional extended super-frame with l ones appended (l is the dimensionality of Oₜ) and W is the linear operator.

In this example, W is derived through a Principal Component Analysis (PCA) [7] applied to the standardized super-frame (i.e. normalized in mean and variance). μ and σ are the vectors with the mean and standard deviation computed for the training dataset. Similarly, V denotes the l×λ matrix with the principal λ eigenvectors of the data in its columns. Then, the linear operator W is given by,

W=V^{T}D, (8)

and

$$D = ( \begin{matrix}1 / {σ}_{1} & … & 0 & - {μ}_{1} / {σ}_{1} \\ ⋮ & ⋱ & ⋮ & ⋮ \\ 0 & … & 1 / {σ}_{l} & - {μ}_{l} / {σ}_{l}\end{matrix} ) . \qquad ( 9 )$$

In addition to PCA, alternative linear transformations can be also applied in order to perform dimensionality reduction and decorrelate the PMA super-frames computed in (7) For example, a supervised version of PCA, the Partial Least Squares (PLS) [8] regression technique can be used.

At a fifth transformation stage 305, an optional element-wise transformation can be applied to each feature vector xₜ in order to improve statistical modelling of the articulator features. Here, each feature is normalized in mean and variance using the mean and standard deviations computed for the training dataset.

As will be understood, the fifth stage 305 outputs articulator movement feature data in the form of articulator movement feature vectors.

### Model Training Block

As shown in FIG. 1, the output of the speech signal processing block 105 and the PMA signal processing block 103 are input into the model training block 106. Accordingly, the model training block receives as input the training dataset, i.e. speech feature vectors Y and the articulator movement feature vectors X.

The model training block 106 is arranged to estimate a model \hat{Θ} that represents the relationship between X and Y, where X=(x₀, x₁, . . . , x_{M-1}) and Y=(y₀, y₁, . . . , y_{M-1}) represent the sequences of articulator and speech feature vectors of the training dataset.

An equation which represents joint probability distribution of speech and articulator features is:

$$\hat{Θ} = arg {max}_{Θ} p ( X , Y \vert Θ ) , \qquad ( 10 )$$

In some examples, a Mixture of Factor Analysers (MFA) [9] is used to model the joint probability distributionp(X,Y|Θ), from which a transformation can be derived for converting input articulator movement features into output speech features.

By adopting a MFA model, the following generative model can be assumed,

z=Λ_{z}^{k}ν+μ_{z}^{k}+ε_{z}^{k}, (11)

where z=(x,y) is a super-vector containing the articulator movement feature vectors and speech feature vectors; ν˜N(0,I) is a Gaussian-distributed latent (hidden) variable; Λ_{z}^{k}=[Λₓ^{k}^{^{T}} Λ_{y}^{k}^{^{T}}]^{T} is a transformation matrix that performs the mapping between the latent and articulator and speech features spaces for the k-th component of the MFA; μ_{z}^{k}=(μₓ^{k}^{^{T}},μ_{y}^{k}^{^{T}}) is the mean vector of the k-th component of the MFA, and, ε_{z}^{k}˜N(0,diag(σ_{z}^{k}) is an independent noise process. An additional parameter of the MFA model that does not appear in the above expression is π^{k}, the a priori probability of the k-th component in the MFA.

The parameters of MFA, Θ={(Λ_{z}^{k},μ_{z}^{k},σ_{z}^{k},π^{k}), k=1, . . . , K}, are estimated from the training dataset using the Expectation Maximization (EM) algorithm [11]. Once estimated, it can be shown that the joint probability of the articulator and speech feature vectors can be expressed as,

$$p ( x , y \vert Θ ) ≡ p ( z \vert Θ ) = {\sum }_{k = 1}^{K} {π}^{k} N ( z ; {μ}_{z}^{k} , {Σ}_{z}^{k} ) , \qquad ( 12 )$$

where

Σ_{z}^{k}=Λ_{z}^{k}(Λ_{z}^{k})^{T}+diag(σ_{z}^{k}^{²}). (13)

As will be understood therefore, in certain embodiments, the parameters of the model are estimated using a maximum likelihood estimation process given the training speech feature vectors and the training articulator movement feature vectors. Consequently, the parameters of the model define a joint probability distribution associating articulator movement feature vector input to the model with output speech feature vectors generated by the model. In other words, the parameters of the conversion model are estimated using maximum likelihood estimation given the training data; the parameters of the conversion model define (i.e. represent) a joint probability distribution, and this probability distribution enables input articulator movement data to be converted into speech sound data.

In other embodiments, the conversion model is instantiated as a long short term memory (LSTM) recurrent neural network [15]. In this case, the model directly represents the conditional probability distributionp(X,Y|Θ), where Θ are the model parameters.

The model parameters are optimised to minimise the sum of squared errors of the target feature vectors using the stochastic gradient descent algorithm [16].

Once the parameters of the conversion model have been estimated as described above, data representing the conversion model can be output from the model training block 106 and stored for later use for the speech synthesis process (for example, after the user 101 has undergone a laryngectomy).

The conversion model can be output and stored in any suitable format. The model parameters consist of floating point numbers so the model can be stored in a text file, binary file or a more complex file format (e.g. XML file, etc.).

### Use of the Conversion Model for Speech Synthesis

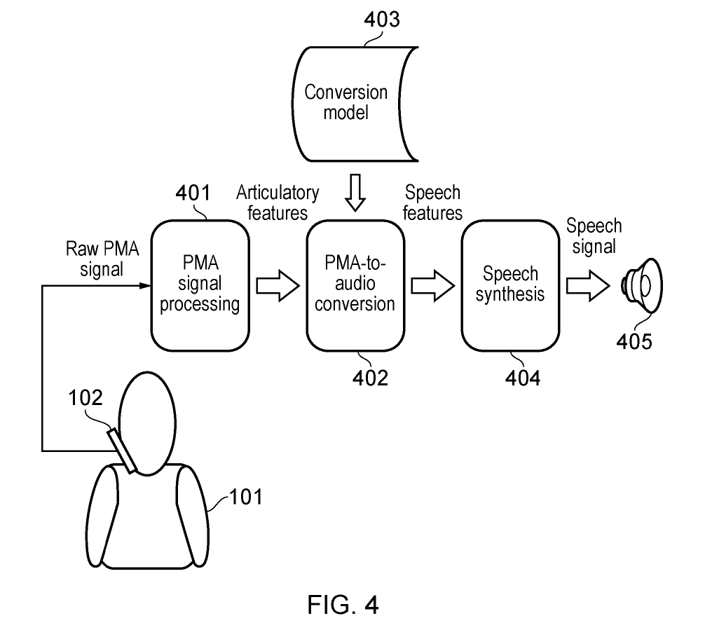

Once the conversion model has been generated as described above, it can be used in a speech synthesis process. An example of such a system for performing such a process is illustrated in FIG. 4.

FIG. 4 provides a schematic diagram of a system for implementing a speech synthesis. Parts corresponding with those shown in FIG. 1 are provided with corresponding reference numerals and for the sake of brevity will not be described again.

As will be understood, the PMA signal processing block 401, the PMA-to-audio conversion block 402 and the speech synthesis block 404 described with reference to FIG. 4 are principally logical designations grouping together a number of related data processing processes and functions. Typically, the data processing performed by these blocks (e.g. the various “stages” explained in more detail below) will be undertaken by a suitably programmed computer system comprising memory and one or more data processors. Various implementations of the system shown in FIG. 4 are described in more detail below.

The components shown in FIG. 4 transform articulator movement captured via the PMA device into audible speech. This audible speech can be played back to the user to close the auditory-feedback loop. That is the system can be arranged so that the user hears what speech sounds are being generated by the system. This allows the user to adapt the way in which they are moving their articulators so that the synthesised speech sound produced by the system more closely matches the speech sound that the user is trying to produce. This mimics the process that takes place when a person produces speech sounds in a normal way.

A user 101 is provided with a PMA device 102 comprising tri-axial sensors as described above and which is coupled to a PMA signal processing block 401. The user has magnets fixed on some of their articulators. When the user moves their articulators, a PMA signal is generated by the PMA device 102 which is input to the PMA signal processing block 401.

The PMA signal processing block 401 is arranged to extract articulator movement feature data comprising articulator movement feature vectors from the PMA signal.

The PMA signal processing block 401 can be implemented in a similar fashion to the PMA signal processing block 103 used to generate the articulator movement data for the training dataset. However, unlike the PMA signal processing block 103 used to generate the training dataset, the PMA signal processing block 401 used in the speech synthesis process typically needs to process the PMA signal in “real time”, or at least to generate synthesised speech sound with a minimised amount of delay. Adaptations required to achieve this are explained in more detail below.

After the articulator movement feature data has been extracted by the PMA signal processing block 401, speech features associated with the extracted articulator features are estimated in a PMA-to-audio conversion block 402 using a conversion model 403 generated as described above.

The PMA-to-audio conversion block 402 outputs speech feature data which is received by a speech synthesis block 404 which generates a time-domain speech sound signal from the speech feature data. The time-domain speech sound signal can then be output as audible sound from an audio unit 405 including a speaker.

The speech sound signal is synthesised as ‘whispered speech’, that is, no information regarding the voicing of the speaker is used to synthesise the speech signal. This is because, typically the PMA technique does not enable this information to be determined.

The components of the arrangement shown in FIG. 4 are explained below in detail.

### PMA Signal Processing Block for Speech Synthesis

As mentioned above, the PMA signal processing block 401 shown in FIG. 4 is implemented in a similar fashion to the PMA signal processing block 103 explained with reference to FIG. 3 and comprises a first background cancellation stage, a second framing stage, a third concatenation stage, a fourth linear transformation stage and a fifth, optional, element-wise transformation stage. However, in order to enable the PMA signal to be processed in real-time, at the framing stage, the sequence compensated PMA samples (o₀, o₁, . . . ) are converted to a series of overlapping frames (ō₀, ō₁, . . . ) as follows:

ōₜ=(o_{t×δ}_{ₒ}_{-ω}_{ₒ}₊₁^{T}, . . . ,o_{t×δ}_{ₒ}^{T})^{T}. (14)

Similarly, at the concatenation stage, the PMA super-frames (O₁, O₂, . . . ) are obtained from the sequence of frames as:

Oₜ=(ō_{t-2K}^{T}, . . . ,ō_{t-K}^{T}, . . . ,ōₜ^{T})^{T}. (15)

The output of the PMA signal processing block 401 is articulator movement feature data in the form of a series of articulator movement feature vectors.

### PMA-to-Audio Conversion Block

The PMA-to-audio conversion block 402 estimates the speech feature vector ŷₜ (t=0, 1, . . . ) associated with each articulator feature vector xₜ output from the PMA signal processing block 401.

Depending on the type of conversion model (i.e., LSTM-RNN or MFA), the speech parameters are estimated in a different manner.

For LSTM-RNN, the input feature vectors x_t are propagated through the network by applying the mathematical operations defined by each node of the network. Finally, the speech parameters y_t are obtained as a linear combination of the output of the last hidden layer of the LSTM network.

In case of using a MFA conversion model, the Minimum Mean Square Error (MMSE) estimation algorithm is used to estimate the speech parameters. Thus,

ŷₜ=E[y|xₜ,Θ], (16)

where Θ is the statistical model representing the joint distribution of articulator and speech features.

A MFA model is used to represent this distribution. Let z=(x^{T}, y^{T})^{T} denotes the super-vector of articulator and speech features. Then, as given by (12), the probability of z is computed as

$$p ( z \vert Θ ) = {\sum }_{k = 1}^{K} {π}^{k} N ( z ; {μ}_{z}^{k} , {Σ}_{z}^{k} ) , \qquad ( 17 )$$

where π^{k} is the prior probability of the k-th component in the MFA (k=1, 2, . . . , K), and N(·;μ_{z}^{k},Σ_{z}^{k}) denotes a multivariate Gaussian distribution with mean vector μ_{z}^{k} and covariance matrix Σ_{z}^{k}. These parameters have the following form:

$${μ}_{z}^{k} = ( \begin{matrix}{μ}_{x}^{k} \\ {μ}_{y}^{k}\end{matrix} ) , \\ {Σ}_{z}^{k} = ( \begin{matrix}{Σ}_{xx}^{k} & {Σ}_{xy}^{k} \\ {Σ}_{yx}^{k} & {Σ}_{yy}^{k}\end{matrix} ) . \qquad ( 18 )$$

Using equation (17) into equation (16), it can be shown that the final expression for the MMSE estimator of the speech features is given by:

$$\begin{matrix}{\hat{y}}_{t} = {\sum }_{k = 1}^{K} P ( k \vert {x}_{t} ) ( {A}^{k} {x}_{t} + {b}^{k} ) , \\ where & ( 19 ) \\ P ( k \vert {x}_{t} ) = \frac{{π}^{k} \cdot N ( {x}_{t} ; {μ}_{x}^{k} , {Σ}_{xx}^{k} )}{{\sum }_{{k}^{′} = 1}^{K} {π}^{{k}^{′}} \cdot N ( {x}_{t} ; {μ}_{x}^{{k}^{′}} , {Σ}_{xx}^{{k}^{′}} )} , & ( 20 )\end{matrix}$$

and the A^{k} and b^{k} are derived from the model parameters as follows,

A^{k}=Σ_{yx}^{k}(Σₓₓ^{k})⁻¹,

b^{k}=μ_{y}^{k}−A^{k}μₓ^{k}. (21)

Although MMSE estimation is used to obtain the speech features associated with given articulator movement, other alternative estimation algorithms can be used to this end. In particular, the Maximum Likelihood Estimation (MLE) algorithm originally proposed in [12] for speech synthesis and also used in [13] for voice conversion, has been shown to yield high-quality speech synthesis within the current invention when combined with MFA models representing both the static and dynamic behaviour of the speech and articulator features.

The output of the PMA-to-audio conversion block 402 is speech feature data comprising a series of speech feature vectors.

An optional transformation can be applied to the speech feature vectors after they are estimated from the input articulator movement feature vectors. Here, each speech feature is re-normalised using the mean and standard deviation estimated for the training dataset,

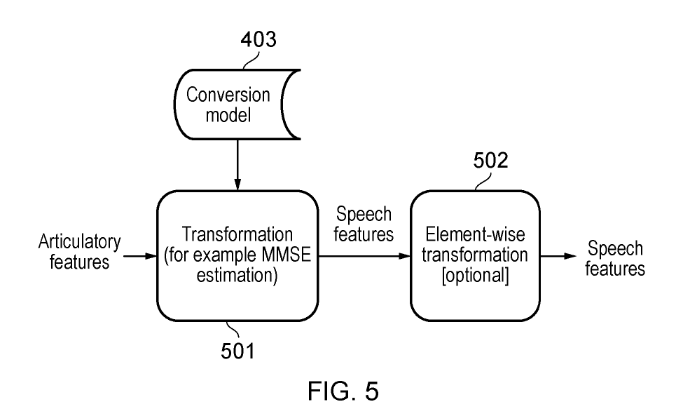

y̅ₜ(i)=μ_{y}(i)+σ_{y}(i)ŷₜ(i), (22)

where ŷₜ(i) is the i-th feature of the estimated speech feature vector at time t, y̅ₜ is the feature vector after re-normalization and, finally, μ_{y} and σ_{y} are the mean and standard deviations vectors computed for the training dataset. This is shown in FIG. 5.

FIG. 5 provides a schematic diagram of an example of an audio conversion process performed by the PMA-to audio conversion block 402 including the optional transformation discussed above.

As shown in FIG. 5, at a first stage 501 the transformation defined by the conversion model 403 is applied to the articulator movement feature vectors. The first stage 501 outputs speech feature vectors to a second stage 502 which performs the element wise transformation as discussed above which outputs re-normalised speech feature vectors.

### Speech Synthesis Block

As described above with reference to FIG. 4, the speech synthesis block 404 receives the speech feature data (i.e. the speech feature vectors) from the PMA-to-audio conversion block 402. The speech synthesis block 404 then generates a time-domain speech sound signal from the speech feature data which can then be output as audible sound from an audio unit 405.

Typically, the speech sound signal is synthesised as ‘whispered speech’ as PMA is a technique that does not have direct access to voicing information e.g. pitch. Hence, white Gaussian noise is used as the excitation signal when synthesising the time-domain speech signal from the speech features describing the speaker's vocal tract.

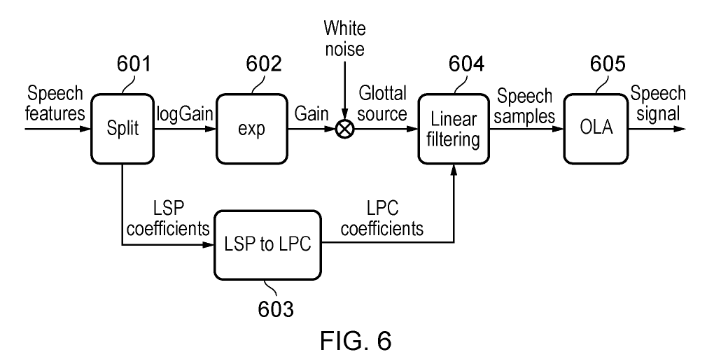

FIG. 6 provides a schematic diagram of an example of a speech synthesis process performed by the speech synthesis block 404.

As shown in FIG. 6, at a first stage 601, each speech feature vector is split into two different type of parameters: the logarithmic gain on one side and the LSP coefficients representing the vocal tract on the other side.

At a second stage 602 the logarithmic gain is exponentiated to yield a gain, while at a third stage block 603 the LSP parameters are transformed into LPC coefficients using the method described in [3] [14].

As mentioned above G and (a₁, . . . , a_{q}) represent the gain and LPC parameters, respectively. Furthermore, the excitation signal modelling the air coming from the lungs is represented as u(n) and, as mentioned above, it consists of white Gaussian noise. Then, an audible whisper speech signal s(n) is synthesised by a linear filtering block 604 as follows,

$$s ( n ) = {\sum }_{i = 1}^{q} {a}_{i} s ( n - i ) + Gu ( n ) . \qquad ( 23 )$$

Finally, at a fifth stage 605 the overlap-add (OLA) method is used to combine the speech signal synthesised for the current speech frame with other signal synthesised for neighbouring frames, so that the joint points of the signals are smoothed.

The arrangement described with reference to FIG. 4 can be implemented in any suitable manner. For example, in certain embodiments, suitable software providing the functionality of the PMA signal processing block 401, the PMA-to-audio conversion block 402 and the speech synthesis block 404 is provided in the form of an “app” loaded on a device such as a smartphone. The smartphone is provided with memory and a processor and is equipped with an audio unit 405 to produce the synthesised speech sound. Data providing the conversion model 403 is uploaded on to the smartphone.

A user, fitted with articulator magnets, wears a PMA device which functions as described above. The PMA device is coupled to the smartphone in any suitable way. In certain embodiments, the PMA device is provided with short-range wireless data communication means, for example a Bluetooth transceiver, which is arranged to transmit the PMA signals to a similar transceiver provided in the smartphone. In other embodiments, the PMA device is coupled to the smartphone using a physical wire (e.g. via a USB interface).

In this way, PMA signals are generated by the PMA device, sent to the smartphone, which then generates the synthesised speech sound.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### REFERENCES

[1] J. M. Gilbert, S. I. Rybchenko, R. Hofe, S. R. Ell, M. J. Fagan and R. K. G. P. D. Moore, “Isolated word recognition of silent speech using magnetic implants and sensors,” Med. Eng. Phys., vol. 32, no. 10, pp. 1189-1197, 2010.
[2] J. Makhoul, “Linear prediction: A tutorial review,” Proceedings of the IEEE, vol. 63, no. 4, pp. 561-580, 1975.
[3] F. Itakura, “Line spectrum representation of linear predictive coefficients of speech signals,” J. Acoust. Soc. Amer., vol. 57, no. 35, 1975.
[4] L. R. Rabiner and R. W. Schafer, Digital Processing of Speech Signals, Prentice Hall, 1978.
[5] T. Fukada, K. Tokuda, T. Kobayashi and S. Imai, “An adaptive algorithm for mel-cepstral analysis of speech,” in ICASSP, 1992.
[6] K. Koishida, K. Tokuda, T. Kobayashi and S. Imai, “Spectral representation of speech based on mel-generalized cepstral coefficients and its properties,” IEICE Trans, vol. 75, no. 7, p. 1124-1134, 1992.
[7] I. T. Jolliffe, Principal component analysis, Springer, 2002.
[8] S. de Jong, “SIMPLS: An alternative approach to partial least squares regression,” Chemometrics Intell. Lab. Syst., vol. 18, no. 3, p. 251-263, 1993.
[9] Z. Ghahramani and G. E. Hinton, “The EM Algorithm for Mixtures of Factor Analyzers,” University of Toronto, 1997.
[10] Y. Stylianou and O. M. E. Cappé, “Continuous probabilistic transform for voice conversion,” IEEE Trans. Speech Audio Process., vol. 6, no. 2, p. 131-142, 1998.
[11] A. Dempster, N. Laird and D. Rubin, “Maximum Likelihood from Incomplete Data via the EM Algorithm,” Journal of the Royal Statistical Society, Series B, vol. 39, no. 1, p. 1-38, 1977.
[12] K. Tokuda, T. Yoshimura, T. Masuko, T. Kobayashi and T. Kitamura, “Speech parameter generation algorithms for HMM-based speech synthesis,” in ICASSP, 2000.
[13] T. Toda, A. W. Black and K. Tokuda, “Voice Conversion Based on Maximum-Likelihood Estimation of Spectral Parameter Trajectory,” IEEE Trans. Speech Audio Process., vol. 15, no. 8, pp. 2222-2235, 2007.
[14] I. V. McLoughlin, “Line spectral pairs,” Signal Processing, vol. 88, no. 3, pp. 448-467, 2008.
[15] S. Hochreiter and J. Schmidhuber, “Long short-term memory,” Neural Computation vol. 9, no. 8, pp. 1735-1780, 1997.
[16] C. M. Bishop, “Pattern Recognition and Machine Learning,” Springer-Verlag New York, 2006.

1. A method of synthesising speech, comprising
inputting articulator movement data to a conversion model, said conversion model comprising parameters representing a relationship between speech articulator movements and speech sound;
transforming by the conversion model said articulator movement data into synthesised speech sound data in accordance with the parameters, wherein
the parameters of said conversion model are estimated based on training articulator movement data and training speech sound data, said training speech sound data associated with training speech sound and said training articulator movement data associated with articulator movement of a user produced in accordance with the training speech sound.

2. A method according to claim 1, wherein the training speech sound is produced by the user and said training articulator movement data is associated with articulator movement produced when the user produces the training speech sound.

3. A method according to claim 1, wherein the training articulator movement data is associated with articulator movement produced by the user when the user mouths along with the training speech sound.

4. A method according to claim 1, wherein the articulator movement data input to the conversion model corresponds to input articulator movement feature vectors.

5. A method according to claim 4, wherein the synthesised speech sound data comprises output speech feature vectors produced by the conversion model when transforming the input articulator movement feature vectors.

6. A method according to claim 5, wherein the output speech feature vectors are estimated from the articulator movement feature vectors by applying a non-linear transformation that depends on the conversion model parameters.

7. A method according to claim 1, further comprising converting the synthesised speech sound data to an audible time domain signal.

8. A method of generating a conversion model for synthesising speech, said method comprising:
receiving training articulator movement data and training speech sound data, said training speech sound data associated with training speech sound and said training articulator movement data associated with articulator movement of a user produced in accordance with the training speech sound, and
estimating parameters of the conversion model based on the training articulator movement data and training speech sound data, said parameters representing a relationship between articulator movement and speech sound.

9. A method according to claim 8, wherein the training speech sound is produced by the user and said training articulator movement data is associated with articulator movement produced when the user produces the training speech sound.

10. A method according to claim 8, wherein, the training articulator movement data is associated with articulator movement produced by the user when the user mouths along with the training speech sound.

11. A method according to claim 9, further comprising
extracting the training speech sound data from speech sound signals captured when the user makes the training speech sound, and
extracting the training articulator movement data from articulator movement signals captured when the user produces the training speech sound.

12. A method according to claim 11, wherein capturing the speech sound signals and capturing the articulator movement signals occurs substantially simultaneously.

13. A method according to claim 11, wherein the training speech sound data comprises training speech feature vectors, and the training articulator movement data comprises training articulator movement feature vectors.

14. A method according to claim 11, further comprising
using a training procedure to estimate the parameters given the training speech feature vectors and the training articulator movement feature vectors, the parameters defining a joint or conditional probability distribution associating articulator movement feature vectors input to the conversion model with output speech feature vectors output from the conversion model.

15. A method according to claim 14, wherein applying the conditional probability distribution is represented either as a recurrent neural network or as a statistical mixture model comprising a number of probability distributions weighted by corresponding mixture weights.

16. A method according to claim 15, wherein the method according to claim 15, wherein the recurrent neural network is a long short term memory (LSTM) recurrent neural network.

17. A method according to claim 15, wherein the statistical mixture model is a mixture of factor analysers (MFA).

18. (canceled)

19. A method according to claim 11, comprising extracting the training speech feature vectors from the speech sound signals using linear predictive coding (LPC).

20. A method according to claim 11, comprising extracting the training articulator movement feature vectors from the articulator movement signals using principal component analysis (PCA).

21. A system for synthesising speech, comprising a conversion model implemented on a data processor, said conversion model comprising parameters representing a relationship between speech articulator movements and speech sound, said conversion model arranged
to receive input articulator movement data, and responsive to receiving the input articulator movement data,
to transform the input articulator movement data into synthesised speech sound data in accordance with the parameters, wherein
the parameters of the conversion model are estimated based on training articulator movement data and training speech sound data, said training speech sound data associated with training speech sound and said training articulator movement data associated with articulator movement of a user produced in accordance with the training speech sound.

22-26. (canceled)
